(19) United States
(12) Patent Application Publication
(10) Pub. No.: US 2009/0022176 A1
(43) Pub. Date: Jan. 22, 2009

(54) SYSTEM AND METHOD FOR CONVERTING COMMUNICATION INTERFACES AND PROTOCOLS

(76) Inventor: James T. Nguyen, Reseda, CA (US)

Correspondence Address: CHRISTIE, PARKER & HALE, LLP, PO BOX 7068, PASADENA, CA, 91109-7068, US

(21) Appl. No.: 11/969,808

(22) Filed: Jan. 4, 2008

Related U.S. Application Data
(60) Provisional application No. 60/951,194, filed on Jul. 21, 2007.

(51) Int. Cl. H04J 3/22

(52) U.S. Cl. 370/466

(57) ABSTRACT

A system and method for converting communication interfaces and protocols is provided. In one embodiment, the invention relates to a system for converting data including a first interface configured to communicate using an HDMI standard, the first interface receiving HDMI data from a plurality of first communication channels, a second interface configured to communicate using a second communication protocol, the second interface having at least one second communication channel, and a circuitry coupled to the first interface and to the second interface, the circuitry configured to receive HDMI data from the first interface, multiplex at least a portion of the HDMI data received via the first interface onto the at least one second communication channel in accordance with the second communication protocol.

### CROSS REFERENCE TO RELATED APPLICATIONS

The present application claims the benefit of Provisional Application No. 60/951,194, filed Jul. 21, 2007, entitled “SYSTEM AND METHOD FOR CONVERTING COMMUNICATION INTERFACES AND PROTOCOLS”, the contents of which are expressly incorporated herein by reference in their entirety.

### BACKGROUND

The present invention relates generally to communication interfaces and protocols, and more particularly to converting from one communication interface and protocol to another communication interface and protocol.

High definition multimedia interface (HDMI) is an audiovisual standard with a defined communication interface and protocol that is used to transport audio, video, and management information between audiovisual devices. The HDMI information can be communicated via a single audiovisual cable from an audiovisual device such as a DVD player to another audiovisual device such as a television. HDMI features include the capability to transmit billions of colors, variable high definition screen resolutions and high refresh rates for smooth motions sequences. HDMI also includes multi-channel digital compressed and uncompressed audio.

The digital audio and video data transported using HDMI is transmitted electrically using a transition minimized differential signal (TMDS) interface which is capable of sending high speed data with low noise. HDMI further includes device management control via two separate management buses: the consumer electronics control (CEC) bus and the display data channel (DDC) bus based on part of the inter-integrated circuit (I2C) bus. The DDC bus can be used for product identification and authentication of copyrighted material before the video information is transmitted, while the CEC bus can allow a single remote control module to control multiple HDMI devices within a CEC bus chain. The primary medium used to transmit the HDMI information is copper wires which can drive the HDMI signals for a limited distance. HDMI devices are generally either sources of HDMI data or sinks of HDMI data. HDMI data is generally transferred from source to sink. Thus, HDMI communication is generally in one direction.

### SUMMARY

The invention relates to a system and method for converting communication interfaces and protocols. In one embodiment, the invention relates to a system for converting data including a first interface configured to communicate using an HDMI standard, the first interface receiving HDMI data from a plurality of first communication channels, a second interface configured to communicate using a second communication protocol, the second interface having at least one second communication channel, and a circuitry coupled to the first interface and to the second interface, the circuitry configured to receive HDMI data from the first interface, multiplex at least a portion of the HDMI data received via the first interface onto the at least one second communication channel in accordance with the second communication protocol.

In another embodiment, the invention relates to a system for converting data including a first interface configured to communicate using a first communication protocol, the first interface for receiving serial data from a first communication channel, a second interface configured to communicate using an HDMI standard, the second interface having a plurality of second communication channels, and a circuitry coupled to the first interface and to the second interface, the circuitry configured to receive the serial data from the first interface, and de-multiplex at least a portion of the serial data onto the plurality of second communication channels in accordance with the HDMI standard.

In yet another embodiment, the invention relates to a method for communicating HDMI information including receiving HDMI audiovisual data and HDMI control data from a first interface, storing the HDMI audiovisual data and HDMI control data, multiplexing the HDMI audiovisual data and HDMI control data into a transmit data stream provided to a second interface, de-multiplexing HDMI audiovisual data and HDMI control data from a receive data stream via a second interface, storing the de-multiplexed HDMI audiovisual data and HDMI control data from the receive data stream, providing the de-multiplexed HDMI audiovisual data and HDMI control data to the first interface.

### BRIEF DESCRIPTION OF THE DRAWINGS

FIG. 1 is a schematic block diagram of a HDMI protocol converter in accordance with an embodiment of the present invention.

FIG. 2 is a schematic block diagram of an HDMI to XFP protocol converter (HDMI to serial module) in accordance with an embodiment of the present invention.

FIG. 3 is a schematic block diagram of an HDMI to XFP protocol converter (HDMI to serial module) receiving control signals in accordance with an embodiment of the present invention.

FIG. 4 is a schematic block diagram of an XFP to HDMI protocol converter (serial to HDMI module) in accordance with an embodiment of the present invention.

FIG. 5 is a schematic block diagram of an XFP to HDMI protocol converter (serial to HDMI module) configured to transmit control signals in accordance with an embodiment of the present invention.

FIG. 6 is a schematic block diagram of a HDMI to serial module including an FPGA and a XAUI PHY in accordance with an embodiment of the present invention.

FIG. 7 is a schematic block diagram of an FPGA circuit that can be used with a HDMI to serial module in accordance with an embodiment of the present invention.

FIG. 8 is a schematic block diagram of a HDMI to serial module including an FPGA and a XAUI PHY coupled by a number of differential signals in accordance with an embodiment of the present invention.

FIG. 9 is a schematic block diagram of an FPGA circuit that can be used with a HDMI to serial module in accordance with an embodiment of the present invention.

FIG. 10 is a schematic block diagram of an FPGA circuit including a time division multiplexer that can be used with a HDMI to serial module in accordance with an embodiment of the present invention.

FIG. 11 is a schematic block diagram of an FPGA circuit that can be used with a serial to HDMI module in accordance with an embodiment of the present invention.

FIG. 12 is a schematic block diagram of an FPGA circuit that can be used with a serial to HDMI module in accordance with an embodiment of the present invention.

FIG. 13 is a block diagram of a packet that can be used in accordance with an embodiment of the present invention.

FIG. 14 is a block diagram of a system including two HDMI protocol converters, a television and a DVD player in accordance with an embodiment of the present invention.

FIG. 15 is a perspective view of an XFP module including a front end fiber optic connector and a rear edge connector in accordance with an embodiment of the present invention.

FIG. 16 is a perspective view of an SFP module in accordance with an embodiment of the present invention.

FIG. 17 is a perspective view of an HDMI to XFP protocol converter module in accordance with an embodiment of the present invention.

FIG. 18 is a perspective view of an HDMI to XFP protocol converter module in accordance with an embodiment of the present invention.

FIG. 19 is a table illustrating pin descriptions for an XFP connector in accordance with an embodiment of the present invention.

FIG. 20 is a perspective view of an HDMI to XFP protocol converter module having two light emitting diodes (LEDs) in accordance with an embodiment of the present invention.

FIG. 21 is a block diagram of a system including multiple HDMI protocol converter modules that can distribute video in accordance with an embodiment of the present invention.

FIG. 22 is a block diagram of a system including multiple HDMI protocol converter modules that can distribute video for a security system in accordance with an embodiment of the present invention.

FIG. 23 is a block diagram of a system including multiple HDMI protocol converter modules that can enable video conferencing over long distances in accordance with an embodiment of the present invention.

FIG. 24 is a schematic block diagram of a system including multiple HDMI protocol converter modules and a crosspoint switch in accordance with an embodiment of the present invention.

### DETAILED DESCRIPTION

Turning now to the drawings, embodiments of HDMI protocol converter modules are illustrated. In several embodiments, the HDMI converter modules enable bi-directional communication. In a number of embodiments, the HDMI modules enable communication of HDMI information over long distances. The HDMI modules generally receive data in accordance with one physical interface and protocol such as HDMI, convert the data, and output the data in accordance with a second physical interface and protocol.

In a number of embodiments, the HDMI modules receive data in accordance with the HDMI standard and output the data via a number of serial communication interfaces, including optical communication interfaces such as the small form-factor pluggable interface (SFP), and SFP variants such as XFP and SFP+. The SFP interface/module specifies high speed optical communications that can be used to support a number of applications (e.g. Fibre Channel and Gigabit Ethernet). In other embodiments, the HDMI modules can convert information from the HDMI standard to serial data to be sent via a serial interface that uses differential signaling. In some embodiments, the HDMI modules can be configured as either a serial to HDMI module or an HDMI to serial module. In a number of embodiments, the HDMI modules receive data via a serial interface and output the data using the HDMI standard.

In further embodiments, the HDMI modules can be used to distribute audiovisual content over long distances or to multiple destinations. In some embodiments, audiovisual content is distributed using the HDMI modules and a cross point switch. The HDMI modules can be used in conjunction with a number of different audiovisual or HDMI systems.

Optical communication interfaces, such as SFP, SFP+ and XFP, have been developed to support telecommunication systems. For example, products are designed, for various telecommunications systems, to transmit data over significant distances well beyond 150 kilometers (km) using fiber optic cables. Copper cables are also used, but the transmission distance limits are significantly less (e.g. approximately several kilometers). Many early telecommunication products transmitted data via fiber optic cable using fixed port designs such as small form factor (SFF) fiber optic modules. Such SFF modules were sold with several options including either multimode fiber (SX modules) that could be used for short distances of up to 10 km, or single mode fiber (LX modules) that could be used for long distance applications of more than 10 km and even beyond 150 km.

The single mode fiber LX modules used a variety of wavelengths, including ranges of 1510 nm to 1620 nm. Because of the wide variety in wavelengths used in transmit and receive modules, manufacturers designing the communication products formed a new standard for pluggable modules to replace the fixed fiber optic ports. With the standard, manufacturers could produce modules and chassis with pluggable ports. This reduced the number of different products manufacturers had to stock, increased their production volumes and reduced the cost of goods made by the manufacturers. Using the standard, manufacturers designed many small fiber optic pluggable SFP modules with various fixed wavelengths. The SFP modules in accordance with the various transmission wavelengths are available from a number of manufacturers.

The SFP module is now a standard and supports data rates above 5 gigabits per second (Gbps). SFP has generally become the industry standard for optical to electrical and electrical to electrical conversion in telecommunications. Demand for higher throughput for high speed data in the form of high definition video over long distances led to the formation of the emerging standard of 10 gigabit per second form factor pluggable (XFP) modules. The XFP standard currently supports data rates from 10 to 40 gigabits per second. The electrical interface of XFP is called XFI. The XFP module is not backward compatible with the SFP module, due to differences in the physical size of pluggable modules and the supported data rates. The XFP form factor supports a higher data rate (10 Gbps) than SFP. In addition, XFP modules typically cost ten times more than regular SFP modules. In order to reduce costs, a small form factor pluggable plus (SFP+) standard was developed to support the high speed data rate of 10 Gbps using the same physical dimensions of the SFP housing. The electrical interface for the SFP+ is called SFI.

HDMI incorporates a variety of audio and video standards with various screen resolution bandwidths. Embodiments of the HDMI protocol converters can support a lower resolution bandwidths including television standards of 480i, 480p to 720p. Such protocol converters can also support higher screen ranges including 1080i, 1080p, 1080p @ 120 Hz, and future high screen resolutions. The variety of data rates available using SFP, SFP+ and/or XFP enable a wide variety of resolution bandwidths to be supported by the HDMI protocol converters.

Embodiments of HDMI protocol converters can support all of the TV standards of the countries of the world, including, for example. the national television standards committee (NTSC), phase alternative lines (PAL), Séquentiel couleur à mémoire, French for “Sequential Color with Memory” (SECAM), and any other country TV standards. All of the features of past, current, and future HDMI specifications can be supported. In a number of embodiments, the HDMI protocol converters make use of communication interfaces such as SFP, SFP+ and XFP.

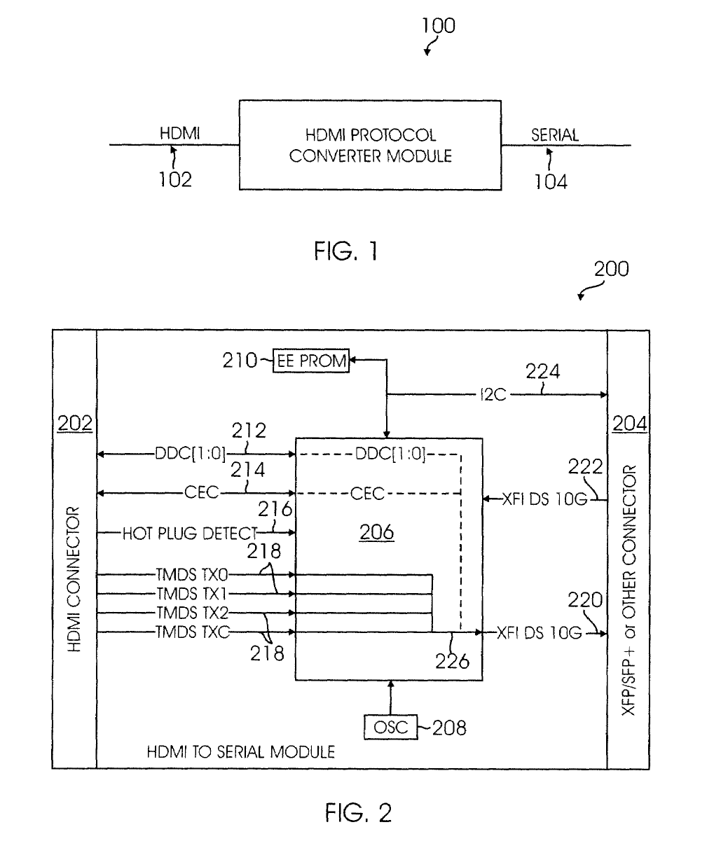

FIG. 1 illustrates a schematic block diagram of a protocol converter in accordance with an embodiment of the present invention. The HDMI protocol converter module 100 includes an HDMI interface 102 configured to receive and/or transmit data in accordance with the HDMI standard and a serial interface 104 configured to communicate using another protocol. The serial interface 104 can support any number of different serial interfaces including both optical interfaces and metallic conductor interfaces. The optical interfaces can include XFP, SFP and/or SFP+. The metallic conductor interfaces can include copper, silver, gold or other similar metallic conductors. In one embodiment, the HDMI module 100 can be configured to operate as either an HDMI to serial module (sink) or a serial to HDMI module (source).

FIG. 2 is a schematic block diagram of an HDMI to XFP protocol converter system (HDMI to serial module) in accordance with an embodiment of the present invention. The system 200 includes an HDMI interface 202, an XFP interface 204, a processing circuitry 206, an oscillator 208 and an EEPROM 210. The HDMI interface 202 provides four transition minimized differential signals (TMDS) 218 (TX0, TX1, TX2, TXC) to the processing circuitry 206. The TX0, TX1 and TX2 signals are data channels, while the TXC signal is a clock channel. In the illustrated embodiment, the TX0, TX1, TX2 and TXC signals are differential signals. A bi-directional display data channel (DDC) 212 is coupled to the HDMI interface 202 and processing circuitry 206. In HDMI systems, devices can generally be either sinks or sources of data. The DDC signals can be used by an HDMI source to discover the configuration and/or capabilities of a HDMI sink. A bi-directional consumer electronic control bus (CEC) 214 is coupled to the HDMI interface 202 and processing circuitry 206. The CEC bus provides high-level control functions between HDMI devices. For example, in one embodiment, the CEC bus allows for a single remote control module to control multiple HDMI devices within a CEC bus chain. A hot plug detect signal 216 is also coupled to the HDMI interface 202 and processing circuitry 206. The hot plug detect signal can be used to indicate the availability of DDC configuration data.

The EEPROM 210 is coupled to the processing circuitry 206 and via an I2C bus 224 to the XFP interface 204. The EEPROM 210 can be used to store information vital to HDMI operations such as vendor/manufacturer identification and high-bandwidth digital content protection (HDCP) keys used to authenticate protected content for audiovisual playback. The oscillator 208 is coupled to the processing circuitry 206 and provides a free running system clock that can be used for system timing by the processing circuitry. In other embodiments, the processing circuitry includes an internal clock and the external oscillator is not used. In some embodiments, another storage device such as a flash memory device can be used instead of the EEPROM.

The processing circuitry 206 provides a XFI (e.g. “ziffie”) transmit channel 220 to the XFP interface 204. XFI is a 10 gigabit per second chip-to-chip electrical interface specification defined as part of an XFP multi-source agreement. XFI can be used for a number of applications including, for example, 10 Gigabit Ethernet, 10 Gigabit/sec Fibre Channel, SONET OC-192, SDH STM-64, 10 Gigabit/sec OTN OTU-2, and parallel optics links. The processing circuitry 206 receives a XFI receive channel 222 from the XFP interface 204.

In operation, the processing circuitry 206 multiplexes the TMDS bus signals along with DDC and CEC signals onto a single serial output 226. In the illustrated embodiment the serial output 226 is coupled to the XFI transmit channel 220 and provided to the XFP interface 204. Thus, in the illustrated embodiment, the parallel data transported using the HDMI interface is serialized and sent over the XFP interface. The XFP interface can be either electrical or optical and can enable data rates of 10 to 40 Gbps. In a number of embodiments, the XFP interface 204 is a module and is hot pluggable. In some embodiments, the HDMI interface 202 is a connector/module that is also hot pluggable. The HDMI to serial module 200 can be made as either a fixed port module in a chassis or produced as a pluggable module configured to couple with any SFP, SFP+, and XFP devices.

In several embodiments, the processing circuitry is implemented using at least one processor and any number of memory components. In one embodiment, the processing circuitry is implemented using programmable logic components (e.g. field programmable gate array (FPGA), complex programmable logic device (CPLD) or the like). In another embodiment, the processing circuitry is implemented using any number of discrete logic components. In yet another embodiment, the processing circuitry is implemented using an application specific integrated circuit (ASIC).

The protocol converter system 200 can enable HDMI communication across very long distances. In a number of embodiments, the protocol converter systems have connectors facilitating quick removal and attachment along with hot pluggable capability. In many embodiments, the protocol converter systems conform to well known standards enabling interoperability with a number of known interfaces supporting a variety of data rates and physical data transport systems.

In one embodiment, any of a variety of small form factor pluggable modules including, for example, SFP, SFP+, future SFF interfaces or other suitable interfaces can be used in place of the XFP interface.

In one embodiment, the XFP interface can be replaced with a generic serial interface. In such case, the serial interface can use differential signals to communicate over long distances. In other embodiments, the serial interface can communicate using single ended signals rather than differential signals

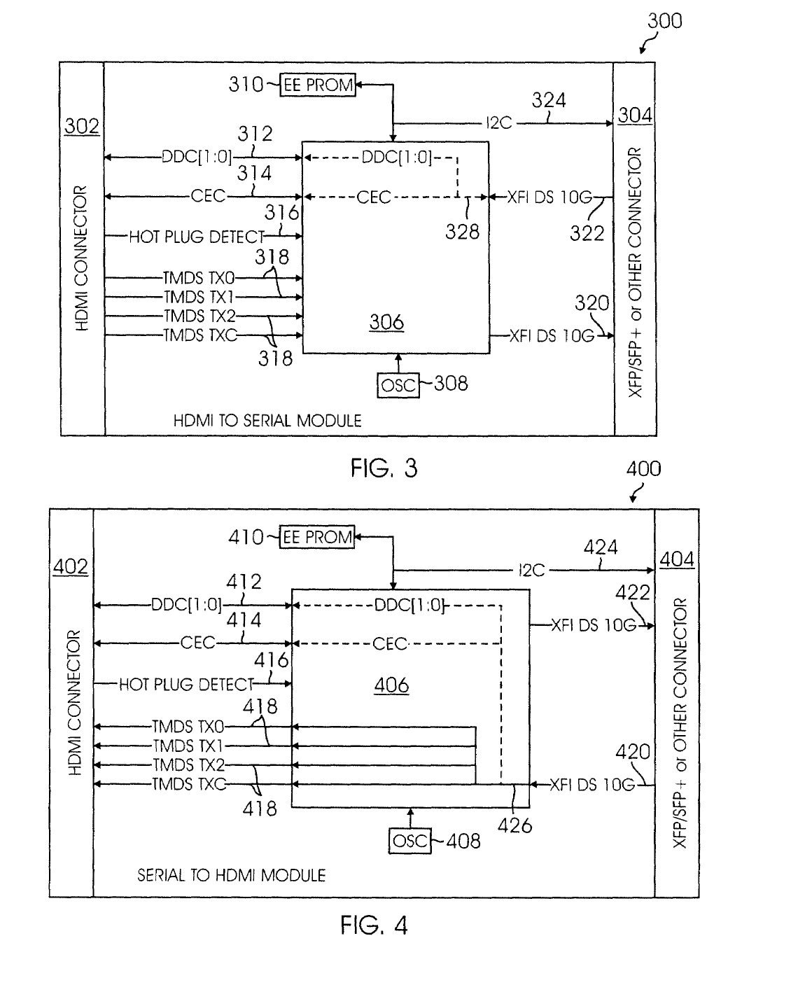

FIG. 3 is a schematic block diagram of an HDMI to XFP protocol converter system (HDMI to serial module) receiving control signals in accordance with an embodiment of the present invention. The protocol converter system 300 includes an HDMI interface 302, an XFP interface 304, a processing circuitry 306, an oscillator 308 and an EEPROM 310. The processing circuitry 306 is coupled to the HDMI interface 302 by two bi-directional DDC channels 312, a bi-directional CEC channel 314, a hot plug detect channel 316, and four TMDS channels 318. The processing circuitry 306 is further coupled to the EEPROM 310 and the oscillator 308. The EEPROM 310 is coupled to the XFP interface 304 using an I2C bus 324. The processing circuitry 306 is coupled to the XFP interface 304 via a XFI transmit channel 320 and a XFI receive channel 322.

In operation, the processing circuitry can receive operations information including high level control functions and HDMI device capabilities via the XFI receive channel 322. The processing circuitry can not only send the multiplexed audiovisual and management data, but at the same time receive the management data from XFI receive channel 322 to the processing circuitry 306 and de-multiplex the operations information from a serialized format and provide it to the HDMI interface 302. In some embodiments, the processing circuitry 306 can otherwise operate as discussed above for the embodiment illustrated in FIG. 2.

FIG. 4 is a schematic block diagram of an XFP to HDMI protocol converter system (serial to HDMI module) in accordance with an embodiment of the present invention. The protocol converter system 400 includes an HDMI interface 402, an XFP interface 404, a processing circuitry 406, an oscillator 408 and an EEPROM 410. The processing circuitry 406 is coupled to the HDMI interface 402 by two bi-directional DDC channels 412, a bi-directional CEC channel 414, a hot plug detect channel 416, and four TMDS channels 418. The processing circuitry 406 is also coupled to the EEPROM 410 and the oscillator 408. The EEPROM 410 is coupled to the XFP interface 404 using an I2C bus 424. The processing circuitry 406 is coupled to the XFP interface 404 via a XFI transmit channel 422 and a XFI receive channel 420.

The EEPROM 410 can be used to store information vital to HDMI operations such as vendor/manufacturer identification and high-bandwidth digital content protection (HDCP) keys used to authenticate protected content for audiovisual playback. The oscillator 408 is coupled to the processing circuitry 406 and provides a free running system clock that can be used to supply the system timing for the processing circuitry. In other embodiments, the processing circuitry includes an internal clock and the external oscillator is not used. In many embodiments, the system timing/clock is recovered from the XFI receive channel 420.

In operation, the processing circuitry 406 receives serial data via the XFI receive channel 420. The processing circuitry de-multiplexes the serial data into three TMDS data channels, the TMDS clock channel, and the DDC and CEC channels. In some embodiments, the TMDS clock can be recovered from the serial data. In other embodiments, the TMDS clock is generated by the processing circuitry 406 using a clock signal generated by the oscillator 408.

In several embodiments, the serial to HDMI module 400 can be used in conjunction with the HDMI to serial modules of FIG. 2 or FIG. 3 to enable HDMI communication across very long distances. In some embodiments, the HDMI interface 402 and XFP interface 404 can operate as described above for the embodiment of FIG. 2. For example, the protocol converter systems 400 can have connectors facilitating quick removal and attachment along with hot pluggable capability. In many embodiments, the protocol converter systems 400 conform to well known standards enabling interoperability with a number of known interfaces supporting a variety of data rates and physical data transport systems. In some other embodiments, the protocol converter systems 400 can be remotely managed via the I2C bus 424.

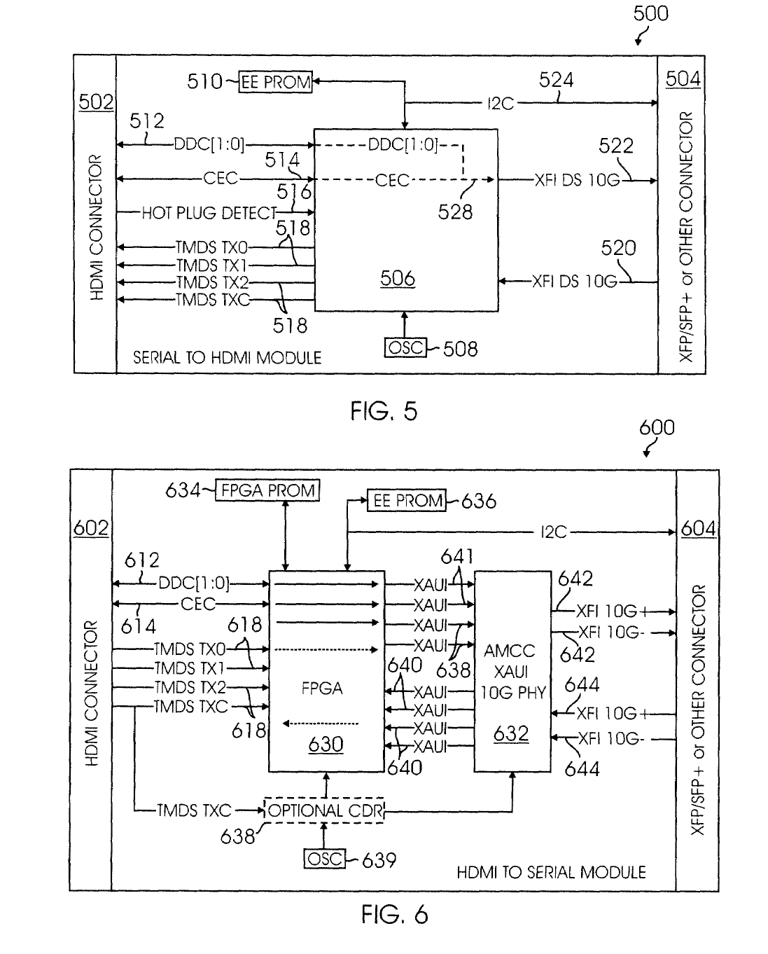

FIG. 5 is a schematic block diagram of an XFP to HDMI protocol converter (serial to HDMI module) configured to transmit control signals in accordance with an embodiment of the present invention. The protocol converter system 500 includes an HDMI interface 502, an XFP interface 504, a processing circuitry 506, an oscillator 508 and an EEPROM 510. The processing circuitry 506 is coupled to the HDMI interface 502 by two bi-directional DDC channels 512, a bi-directional CEC channel 514, a hot plug detect channel 516, and four TMDS channels 518. The processing circuitry 506 is also coupled to the EEPROM 510 and the oscillator 508. The EEPROM 510 is coupled to the XFP interface 504 using an I2C bus 524. The processing circuitry 506 is coupled to the XFP interface 504 via a XFI transmit channel 522 and a XFI receive channel 520.

The EEPROM 510 can be used to store information vital to HDMI operations such as vendor/manufacturer identification and high-bandwidth digital content protection (HDCP) keys used to authenticate protected content for audiovisual playback. The oscillator 508 is coupled to the processing circuitry 506 and provides a free running system clock that can be used to supply the system timing for the processing circuitry. In other embodiments, the processing circuitry includes an internal clock and the external oscillator is not used. In many embodiments, the system timing/clock is recovered from the XFI receive channel 420.

In operation, the processing circuitry 506 receives operations information including high level control functions and HDMI device capabilities via the DDC and CEC channels from the HDMI interface. The processing circuitry 506 multiplexes the operations information from the multiple DDC and CEC channels onto a single serial channel 528. The data from the serial channel 528 is provided via the XFI transmit channel 522 to the XFP interface. Thus, in the illustrated embodiment, the HDMI operations information is both transmitted and received (e.g. bi-directional). In the illustrated embodiment, the protocol converter 500 is configured to convert serial data to HDMI data. In other embodiments, the processing circuitry can be re-configured on the fly to allow operation from a serial to HDMI module or a HDMI to serial converter module.

FIG. 6 is a schematic block diagram of an embodiment of a HDMI to serial module that includes an FPGA and a XAUI PHY in accordance with aspects of the present invention. The HDMI to serial module 600 includes an HDMI interface 602, an FPGA 630, an AMCC 10G XAUI PHY 632, an XFP interface 604, an FPGA programmable read only memory (PROM) 634, an EEPROM 636, an optional clock data recovery circuit (CDR) 638 and an oscillator 639. The FPGA 630 is coupled to the HDMI interface 602 by two bi-directional DDC channels 612, a bi-directional CEC channel 614, a hot plug detect channel 616 and four TMDS channels 618 including three data channels and one clock channel. The FPGA 630 is also coupled to the FPGA PROM 634 and the EEPROM 636. The FPGA 630 is further coupled to the oscillator 639 via the optional CDR 638. The EEPROM 636 is coupled to the XFP interface 604 using an I2C bus. The optional CDR 638 is coupled to the TMDS TXC clock channel 618, the oscillator 639 and the AMCC PHY 632. The FPGA 630 is coupled to the AMCC PHY 632 by four XAUI transmit channels 641 and four XAUI receive channels 640. XAUI is a standard interface used for transmission of high speed data at speeds of 10 gigabit and above. The “X” in the term XAUI stands for the Roman numeral ten indicating 10 gigabit, while the remainder stands for “Attachment Unit Interface”. The XAUI channels generally include high speed differential signals where clock information is often embedded with transmitted data. The AMCC PHY 632 is coupled to the XFP interface 604 via a differential XFI transmit channel 642 and a differential XFI receive channel 644.

In operation, the FPGA 630 receives data via the four TMDS channels 618. The FPGA 630 can output the three TMDS data channels onto three XAUI transmit channels with the TMDS clock embedded in the data being transported by the transmit channels. The FPGA 630 can multiplex operations and control information from the DDC and CEC channels onto the last of the four XAUI transmit channels. The XAUI receive channels 640 are received by the AMCC PHY 632. The AMCC PHY 632 multiplexes the four differential XAUI channels to a single serial data stream which is outputted via the differential XFI transmit channel 642. In one embodiment, the four XAUI channels operate at 3.125 Gbps while the serial data stream operates at 9.95 to 10.5 Gbps. Similarly, the AMCC PHY 632 de-multiplexes serial data received via the XFI receive channel 644 onto the four XAUI receive channels 640. In one embodiment, the AMCC PHY 632 is a QT2035 XFI-to-XAUI PHY produced by Applied Micro Circuits Corporation of Sunnyvale, Calif. In some embodiments, the AMCC PHY uses 8/10 encoding which maps 8 bit symbols to 10 bit symbols to achieve optimal DC balance. In one embodiment, the AMCC PHY uses 64/66 bit conversion. In a number of embodiments, the AMCC PHY aligns the four channels for XAUI data as it serializes them.

In a number of embodiments, the FPGA 630 is a Virtex type FPGA produced by Xilinx Incorporated of San Jose, Calif. In several of such embodiments, the Virtex FPGA can have a core or predefined set of logic cells that support a XAUI interface. The FPGA PROM 634 is a memory device that can store the firmware for the FPGA. In one embodiment, the PROM is a re-programmable memory device. The EEPROM 636 can be used to store information vital to HDMI operations such as vendor/manufacturer identification and HDCP keys used to authenticate protected content for audiovisual playback. The EEPROM 636 can also store other configuration information related to the HDMI interface or the XFP interface. In one embodiment, a single EEPROM is used to store both the HDMI configuration information and the FPGA firmware. In one embodiment, the EEPROM and/or FPGA PROM can be replaced with one or more flash memory devices or other suitable memory devices.

In one embodiment, the optional CDR circuit 638 can be used to recover the TMDS clock while data is being sent via the TMDS data channels. This can enable the FPGA clock to be aligned with the incoming data. The recovered clock can be used within both the FPGA and the AMCC PHY. In the event that HDMI data is not being received, the CDR circuit can use the oscillator 639 to generate a suitable clock for the FPGA and AMCC PHY.

In several embodiments, the FPGA 630 can be configured such that the system operates as either an HDMI to serial module or a serial to HDMI module. In some embodiments, a user can set the system to select the desired function of the FPGA. In one such case, the user can operate a dipswitch on the HDMI connector to specify transmit or receive mode. In another embodiment, such user preferences are communicated over the I2C bus. In a number of embodiments, the functionality of the HDMI protocol converter system can be configured on the fly.

In some embodiments, the FPGA can be implemented using gate arrays from any number of manufacturers, including, for example, Xilinx or Altera. In one embodiment, the FPGA is a Virtex5 XC5VLX30T FPGA in a FFG665 package which often includes built-in support for the XAUI interface. In such case, the Xilinx Virtex5 FPGA may not have support for TMDS and some level shifting/conversion may be necessary. In some embodiments, the FPGA includes multiple dual port first in first out registers (FIFOs) that help buffer data. In such case, the FIFOs can include half full and half empty flags, which can be helpful in eliminating or reducing overflow and underflow conditions during data transport.

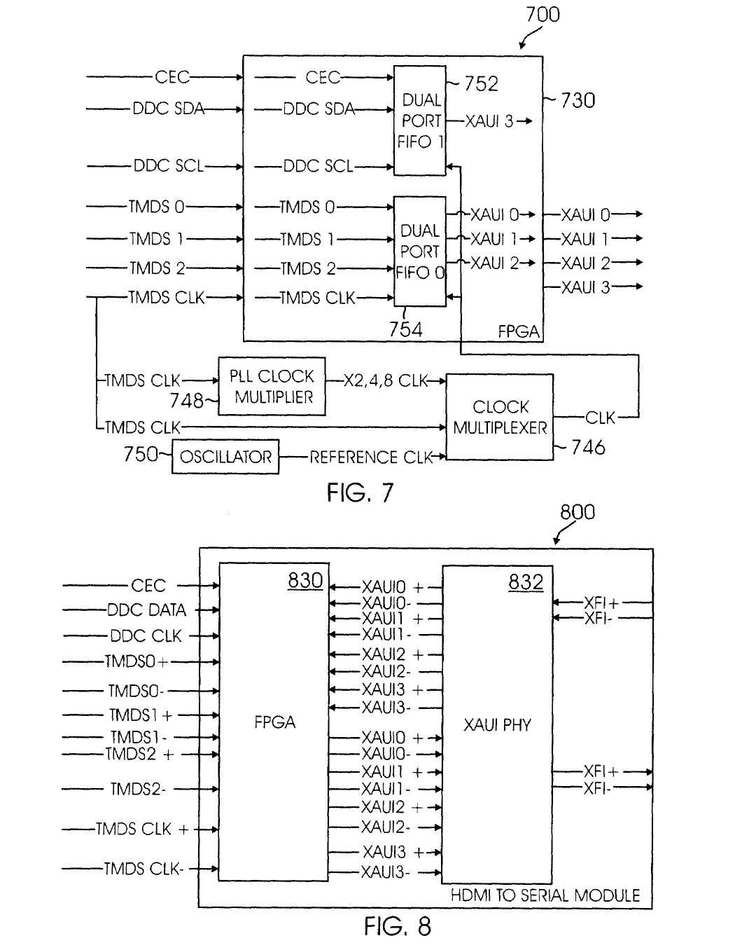

FIG. 7 is a schematic block diagram of a portion of an FPGA circuit that can be used with a HDMI to serial module in accordance with an embodiment of the present invention. The FPGA circuit 700 includes an FPGA 730, a clock multiplexer 746, a phase locked loop (PLL) clock multiplier 748 and an oscillator 750. The clock multiplexer 746 is coupled to the FPGA 730, the PLL clock multiplier 748, and the oscillator 750. The FPGA 730 includes two dual port FIFOs (752, 754) and receives the signals common to an HDMI interface. The FPGA outputs four XAUI transmit channels.

FIFO 752 is coupled to the CEC and DDC HDMI channels along with a clock signal from the clock multiplexer 746. Data taken from FIFO 752 can be provided on XAUI transmit channel three (XAUI 3). FIFO 754 is coupled to the TMDS data and clock channels along with the clock signal from the clock multiplexer 746. Data taken from FIFO 754 can be used on XAUI transmit channels XAUI 0, XAUI 1, and XAUI 2.

In operation, the FPGA receives HDMI data via the TMDS, CEC, and DDC channels. The received data is stored in FIFO 752 and FIFO 754. If the incoming HDMI data is received at a bit rate lower than a FPGA threshold, then the PLL clock multiplier can be used to multiply the received clock to an acceptable frequency. In such case, the FPGA will use a reference clock signal generated by the PLL clock multiplier to output data on the XAUI transmit channels. In some embodiments, the clock rate multiplier is 2, 4, 8 or another factor. In many embodiments, a XAUI data stream has the clock rate embedded within the data stream. If there is no data being sent, the oscillator can provide a reference clock to the FPGA. In some embodiments, the PLL clock multiplier 748 and clock multiplexer 746 are integrated inside the FPGA.

FIG. 8 is a schematic block diagram of a HDMI to serial module 800 including an FPGA 830 and a XAUI PHY 832 coupled by a number of differential signals in accordance with an embodiment of the present invention. The FPGA 830 receives a number of differential signals common to the HDMI specification. The FPGA 830 and XAUI PHY 832 are coupled by XAUI differential transmit and receive signals. The XAUI PHY is coupled by differential XFI transmit and receive signals.

In a number of embodiments, the HDMI to serial module 800 can operate as described previously for the embodiment of FIG. 6.

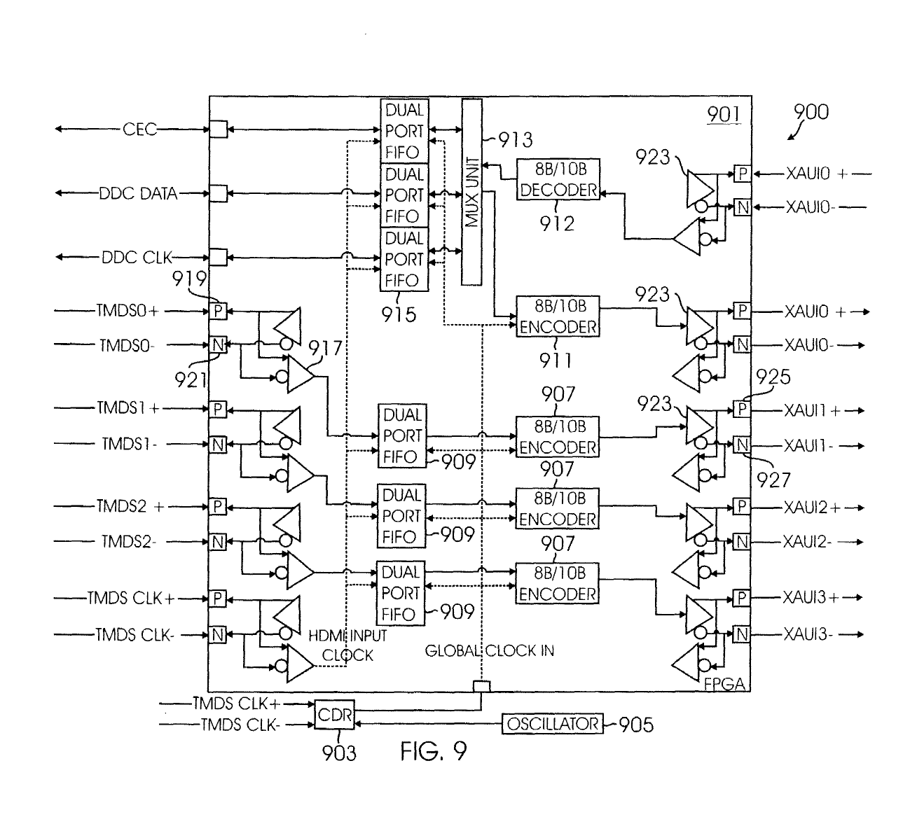

FIG. 9 is a schematic block diagram of an FPGA circuit that can be used with a HDMI to serial module in accordance with an embodiment of the present invention. The FPGA circuit 900 includes an FPGA 901, a clock data recovery circuit (CDR) 903, and an oscillator 905. The CDR is coupled to both the FPGA 901 and the oscillator 905. The FPGA includes four high speed transceivers 917 that accept HDMI signals, six dual port FIFOs (909, 915), a multiplexer unit (“MUX UNIT”) 913, four 8 to 10 (8/10) bit encoders (907, 911), an 8 to 10 (8/10) bit decoder 912 and five XAUI transceivers 923.

Dual port FIFOs 915 are coupled to HDMI control channels and multiplexer unit 913. Multiplexer unit 913 is coupled to 8/10 bit encoder 911 and 8/10 bit decoder 912. The 8/10 bit encoder 911 and 8/10 bit decoder are each coupled to XAUI transceivers 923, which are coupled to XAUI differential outputs. High speed transceivers 917 are coupled to differential contacts. For example, high speed transceiver 917 has a positive differential contact 919 and a negative differential contact 921. Dual port FIFOs 909 are coupled to the high speed transceivers 917 and to 8/10 bit encoders 907. The 8/10 bit encoders 907 each are coupled to XAUI transceivers 923, which are coupled to XAUI differential outputs. The XAUI transceivers 923 can have differential contacts. For example, XAUI transceiver 923 has a positive differential contact 925 and a negative differential contact 927.

In operation, the FPGA 901 can operate as described for the embodiment of FIG. 6. The multiplexer unit 913 can act to multiplex signals provided to the multiplexer. In the one embodiment, the multiplexer unit can multiplex the CEC, DDC DATA and DDC CLK signals onto a data channel provided to 8/10 bit encoder 911. In another embodiment, the multiplexer unit can de-multiplex signals from a single data channel such as the channel provided from the 8/10 bit decoder 912. In some embodiments, the multiplexer unit acts as both a multiplexer and a de-multiplexer. In some embodiments, the multiplexer unit 913 and 8/10 bit decoder 912 will use the system clock for its processing circuitry. In other embodiments, the multiplexer unit 913 and 8/10 bit decoder 912 will use the incoming clock or recovered clock for its processing circuitry.

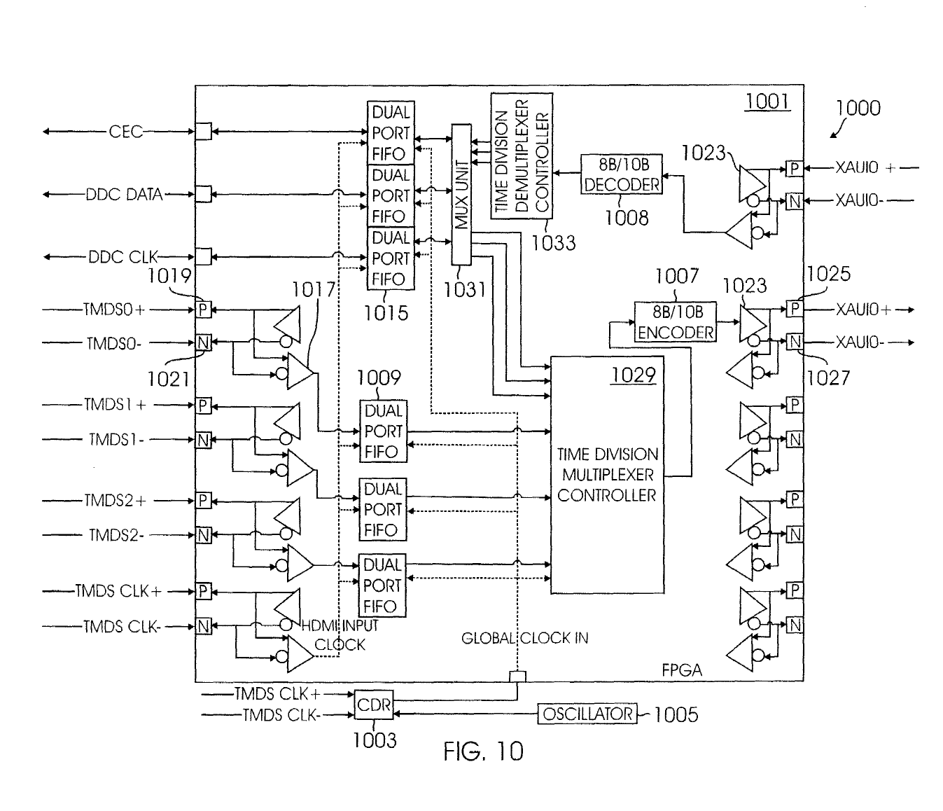

FIG. 10 is a schematic block diagram of an FPGA circuit including a time division multiplexer that can be used with a HDMI to serial module in accordance with an embodiment of the present invention. The FPGA circuit 1000 includes an FPGA 1001, a clock data recovery circuit (CDR) 1003, and an oscillator 1005. The CDR is coupled to both the FPGA 1001 and the oscillator 1005. The FPGA includes four high speed transceivers 1017 that accept HDMI signals, six dual port FIFOs (1009, 1015), a time division multiplexer 1029, a multiplexer unit 1031, a time division de-multiplexer 1033, an 8 to 10 (8/10) bit encoder 1007, an 8 to 10 (8/10) bit decoder 1008 and five XAUI transceivers 1023.

Dual port FIFOs 1015 are coupled to HDMI control channels and multiplexer unit 1031. Multiplexer unit 1031 is coupled to time division multiplexer 1029 and time division de-multiplexer 1033. Time division multiplexer 1029 is coupled to 8/10 bit encoder 1007. The 8/10 bit encoder 1007 is coupled to a XAUI transceiver 1023, which is coupled to XAUI differential outputs. The 8/10 bit decoder 1008 is coupled to a XAUI transceiver 1023 and time division de-multiplexer 1033.

High speed transceivers 1017 are coupled to differential TMDS inputs and have differential contacts. For example, high speed transceiver 1017 has a positive differential contact 1019 and a negative differential contact 1021. Dual port FIFOs 1009 are coupled to the high speed transceivers 1017 and to time division multiplexer 1029. The 8/10 bit encoder 1007 is coupled to XAUI transceiver 1023, which is coupled to XAUI differential outputs. The XAUI transceivers 1023 can have differential contacts. For example, XAUI transceiver 1023 has a positive differential contact 1025 and a negative differential contact 1027. In some embodiments, the time division multiplexer 1029 can divide the output bandwidth to more than a single pair of transceivers allowing for a lower overall transmission speed.

In operation, the FPGA 1001 receives HDMI data via the TMDS data channels and stores the data in FIFOs 1009. The FPGA 1001 receives control data and buffers the data in FIFOs 1015. Time division multiplexer 1029 receives data from FIFOs 1009 and multiplexes the data onto a single data channel which is provided to a XAUI transceiver 1023 via 8/10 bit encoder 1007. Time division multiplexer 1029 also receives control data from FIFOs 1015 via multiplexer unit 1031 and multiplexes the control data onto the single data channel which is provided to a XAUI transceiver 1023 via 8/10 bit encoder 1007. In several embodiments, data from different channels is multiplexed onto a single XAUI data channel. Time division de-multiplexer 1033 receives control data from a XAUI transceiver 1023 via 8/10 bit decoder 1008, de-multiplexes the control data, and provides the control data to FIFOs 1015 via multiplexer unit 1031. In a number of embodiments, the multiplexer unit acts as both a multiplexer and a de-multiplexer. In some embodiments, the multiplexer unit 1031, time division de-multiplexer 1033, and 8/10 bit decoder 1008 will use the system clock for its processing circuitry. In other embodiments, the multiplexer unit 1031, time division de-multiplexer 1033, and 8/10 bit decoder 1008 will use the incoming clock or recovered clock for its processing circuitry.

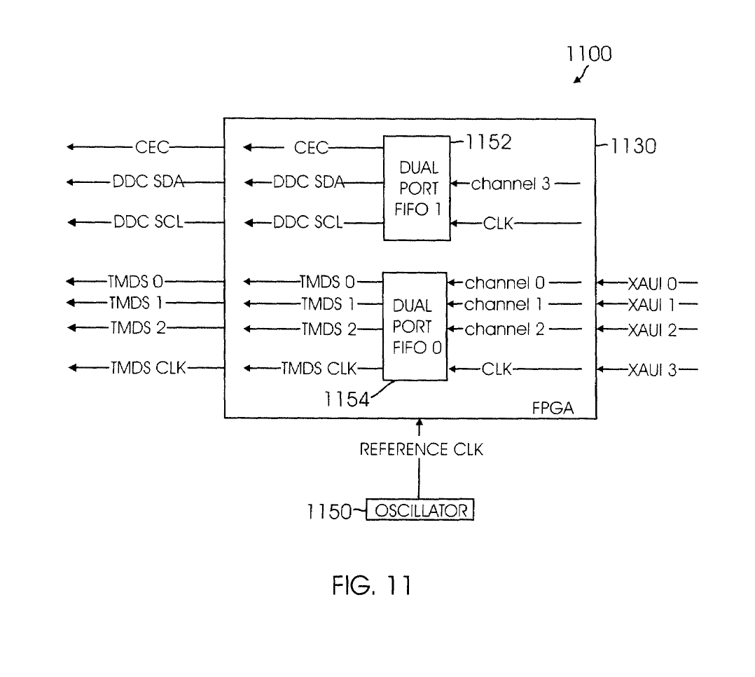

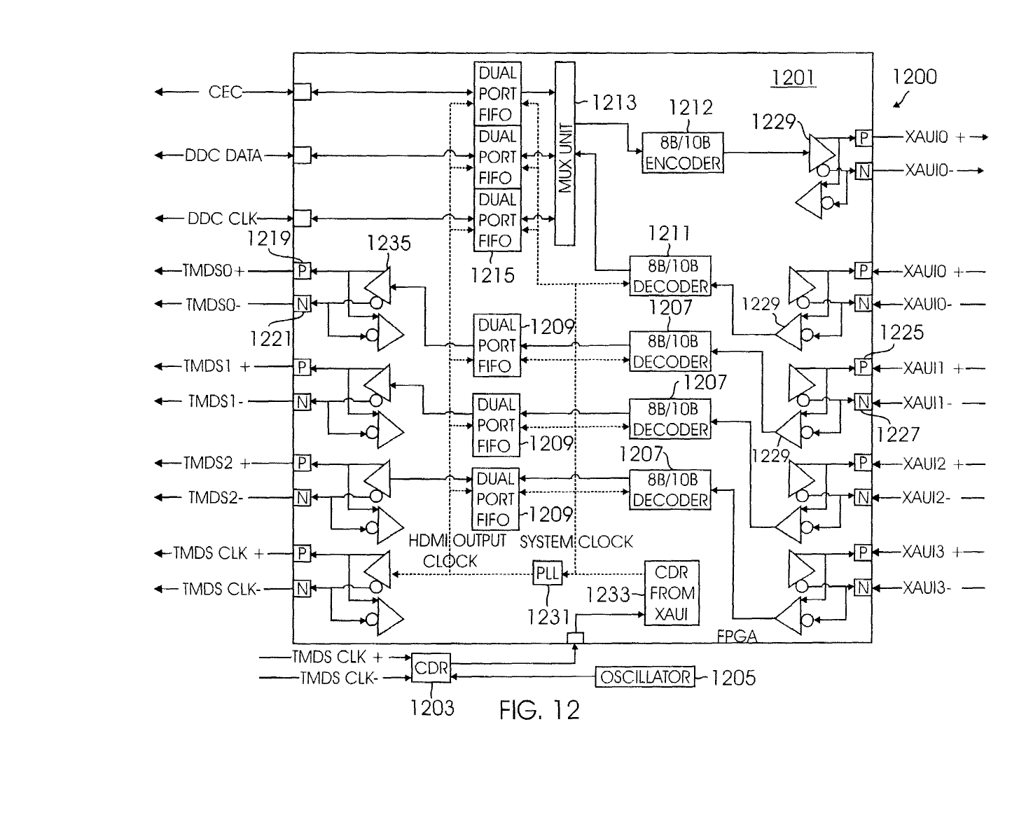

FIG. 11 is a schematic block diagram of an FPGA circuit that can be used with a serial to HDMI module in accordance with an embodiment of the present invention. The FPGA circuit 1100 includes an FPGA 1130 coupled to an oscillator 1150. The FPGA 1130 includes dual port FIFOs 1152 and 1154. FIFO 1152 can receive data from a XAUI data channel and provide the data over the HDMI control data channels. FIFO 1154 can receive data from multiple XAUI data channels and can provide the data to the TMDS channels of an HDMI interface. FIG. 11 is a higher level description of FIG. 12, the Dual Port FIFO 1152

FIG. 12 is a schematic block diagram of an FPGA circuit that can be used with a serial to HDMI module in accordance with an embodiment of the present invention. The FPGA circuit 1200 includes an FPGA 1201, a clock data recovery circuit (CDR) 1203, and an oscillator 1205. The CDR is coupled to both the FPGA 1201 and the oscillator 1205. The FPGA includes four high speed transceivers 1235 that transmit HDMI signals (some level shifting may be required depending on the type of FPGA that is used), six dual port FIFOs (1209, 1215), a multiplexer unit 1213, four 8 to 10 (8/10) bit decoders (1207, 1211), an 8 to 10 (/10) encoder 1212, and five XAUI transceivers 1229. Dual port FIFOs 1215 are coupled to HDMI control channels and de-multiplexer 1213.

Multiplexer unit 1213 is coupled to 8/10 bit decoder 1211 and 8/10 bit encoder 1212. The 8/10 bit decoders (1207, 1211) are each coupled to a XAUI transceiver 1229, which is coupled to XAUI differential inputs. The 8/10 bit encoder 1212 is coupled to a XAUI transceiver 1229. High speed transceivers 1235 are coupled to differential TMDS outputs and have differential contacts. For example, high speed transceiver 1235 has a positive differential contact 1219 and a negative differential contact 1221. Dual port FIFOs 1209 are coupled to the high speed transceivers 1235 and to 8/10 bit decoders 1207. The 8/10 bit decoders 1207 are coupled to XAUI transceivers 1229, which are coupled to XAUI differential inputs. The XAUI transceivers 1229 can have differential contacts. For example, XAUI transceiver 1229 has a positive differential contact 1225 and a negative differential contact 1227.

In operation, the FPGA 1201 receives data from the four XAUI data channels via XAUI transceivers 1229. Data from three XAUI data channels is decoded by the 8/10 bit decoders 1207 and stored in FIFOs 1209. The data from one XAUI data channel is decoded and then de-multiplexed by multiplexer unit 1213, effectively separating out the HDMI control data and providing it onto the appropriate HDMI management data channels. The de-multiplexed data is stored in FIFOs 1215 and is ultimately forwarded through the HDMI control data channels. The data stored in FIFOs 1209 is provided via the high speed transceivers 1235 to the HDMI data channels via an HDMI interface. Control data is also received from the control data channels, stored in FIFOs 1215, encoded using a 8/10 bit encoder 1211 and provided onto a XAUI data channel via a XAUI transceiver 1229.

The multiplexer unit 1213 can act to multiplex signals provided to the multiplexer. In the one embodiment, the multiplexer unit can multiplex the CEC, DDC DATA and DDC CLK signals onto a data channel provided to 8/10 bit encoder 1212. In another embodiment, the multiplexer unit can de-multiplex signals from a single data channel such as the channel provided from the 8/10 bit decoder 1211. In some embodiments, the multiplexer unit acts as both a multiplexer and a de-multiplexer. In some embodiments, the multiplexer unit 1213 and 8/10 bit encoder 1212 will use the system clock for its processing circuitry. In other embodiments, the multiplexer unit 1213 and 8/10 bit encoder 1212 will use the incoming clock or recovered clock for its processing circuitry.

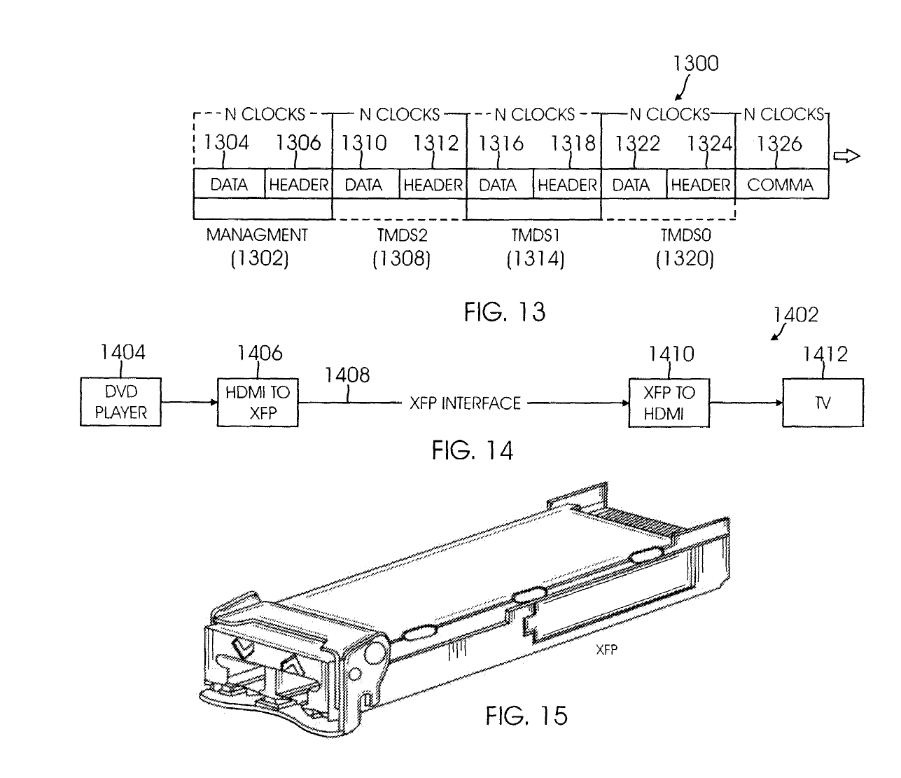

FIG. 13 is a block diagram of a packet 1300 that can be used in accordance with an embodiment of the present invention. The packet 1300 includes a management section 1302, three TMDS data channel sections (1308, 1314, 1320), and a comma section 1326. The management section 1302 includes a data portion 1304 and a header portion 1306. TMDS channel 1308 includes a data portion 1310 and a header portion 1312. Similarly, TMDS channel 1314 includes a data portion 1316 and a header portion 1318. Similarly, TMDS channel 1320 includes a data portion 1322 and a header portion 1324. In other embodiments, the order of the packet 1300 can be reversed.

In operation, HDMI to serial modules and serial to HDMI modules, in accordance with several embodiments of the invention, can transfer data using the packet data format indicated for packet 1300.

FIG. 14 is a block diagram of a system including two HDMI protocol converters (1406, 1410), a television 1412 and a DVD player 1404 in accordance with an embodiment of the present invention. HDMI protocol converter 1406 is configured as a HDMI to serial converter module that receives HDMI data from DVD player 1404 and converts the HDMI data to serial data to be communicated via a XFP link to HDMI converter 1410. HDMI converter 1410 is configured as a serial to HDMI converter module and converts the received XFP serial data to HDMI data and provides it to television (TV) 1412. As XFP supports long distance optical data transmission, the DVD player can be located up to 150 kilometers away from the TV. In some embodiments, the DVD player can be located over 150 kilometers away from the TV.

FIG. 15 is a perspective view of a typical XFP module including a front end fiber optic connector and a rear edge connector that can be used in accordance with a number of embodiments of the present invention. In a number of embodiments, the XFP module or connector can be easily mounted to a printed circuit board having the appropriate mating connector configured to engage the rear edge connector of the XFP module. Similarly, in several embodiments, the front end fiber optical connector is configured for easy attachment and release of a fiber optic cable. In other embodiments, the XFP front end connector can be a copper interface.

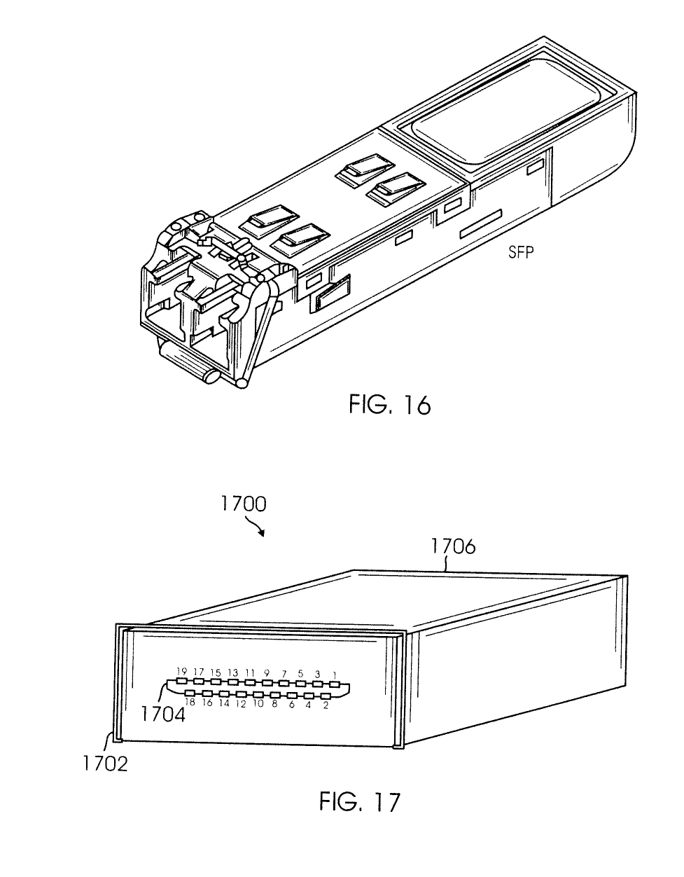

FIG. 16 is a perspective view of an SFP module in accordance with an embodiment of the present invention. In a number of embodiments, the SFP or SFP+ module can be used in a fashion similar to the XFP module of FIG. 15.

FIG. 17 is a perspective view of an HDMI to XFP protocol converter module 1700 in accordance with an embodiment of the present invention. The HDMI converter 1700 includes a bail latch 1702, an HDMI interface 1704 and a board edge connector 1706 (not visible). The bail latch 1702 is mounted on the front of the converter and can be used to lock, unlock and release the converter unit from a surrounding housing (not visible) in which it can be secured. In one embodiment, the HDMI interface connector 1704 is 14 millimeters wide in conformance with the HDMI specification. The rear board edge connector 1706 can be coupled with a mating connector defined by the XFP specification. In one embodiment, the rear board edge connector 1706 is configured to couple with a port of a chassis allowing connection to via multiple ports. In some embodiments, the HDMI interface connector is configured to couple with a port of a chassis allowing connection to via multiple ports.

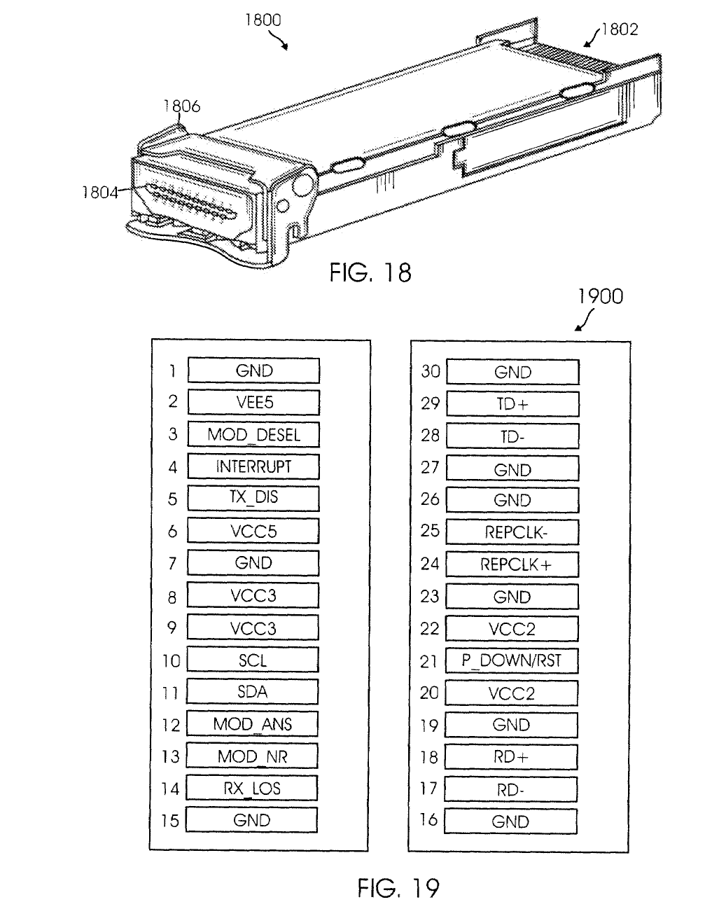

FIG. 18 is a perspective view of an HDMI to XFP protocol converter module in accordance with an embodiment of the present invention. The HDMI converter 1800 includes a bail latch 1806, an HDMI interface 1804 and a board edge connector 1802. In the illustrated embodiment, the HDMI converter can operate as described for the embodiment of FIG. 17.

FIG. 19 is a table illustrating pin descriptions for an XFP connector in accordance with an embodiment of the present invention. In other embodiments, more than or less than the number of illustrated pins can be used. In some embodiments, the XFP connector can use different signal assignments and different naming conventions.

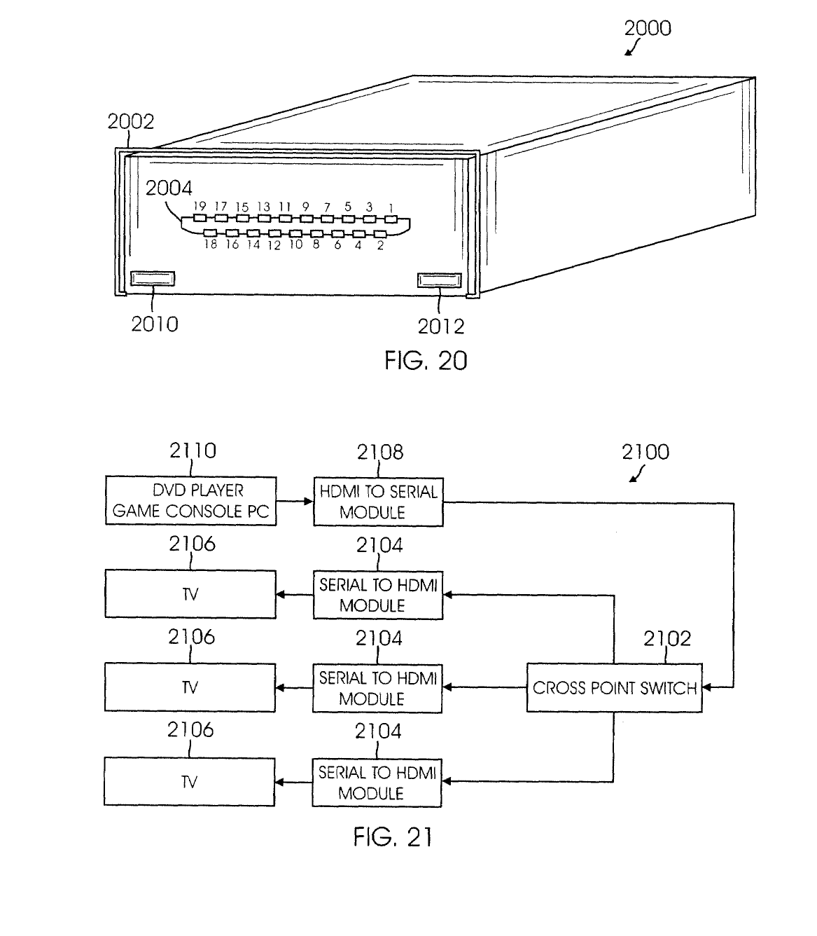

FIG. 20 is a perspective view of an HDMI to XFP protocol converter module 2000 having two LEDs (2010, 2012) in accordance with an embodiment of the present invention. The HDMI converter also includes a bail latch 2002 and a rear edge connector 2000. In the illustrated embodiment, LED 2010 is amber and is indicative of HDMI activity. LED 2012 is green and is indicative of HDMI link. In operation, the HDMI converter acts as a troubleshooting device allowing a user to identify whether problems exist and whether existing problems may have been fixed. In other embodiments, other colors can be used for the LEDs. In some embodiments, the status of other signals or indicators based on combinations of signals can be displayed using the LEDs.

FIG. 21 is a block diagram of a system including multiple HDMI protocol converter modules that can distribute video in accordance with an embodiment of the present invention. The system 2100 includes DVD player 2110 coupled to an HDMI to serial module 2108 coupled to a crosspoint switch 2102 coupled to three serial to HDMI modules 2104, where each serial to HDMI module 2104 is coupled to a television 2106. In operation, the DVD player 2110 provides HDMI data to HDMI to serial module 2108. HDMI to serial module 2108 converts the HDMI data to serial data and provides the serial data to the crosspoint switch 2102. The crosspoint switch 2102 distributes the serial data via the three serial to HDMI modules 2104 to televisions 2106.

In a number of embodiments, the system can be used to distribute content from a audiovisual source to a number of audiovisual sinks. In one embodiment, the DVD player can be replaced with any of a number of audiovisual sources, including, for example, a game console or a personal computer. In one embodiment, the system can be used to test any number of HDMI devices. In such case, the system can be used for compliance testing for a particular standard such as, for example, the HDMI specification. In other embodiments, the system can be used for compliance testing for the purposes of device compliance, interoperability, and compatibility verification. A television unit can replace DVD player 2110 and a variety of devices such as game consoles, personal computers, DVD players can replace television 2106. The system can now be tested in the opposite direction to test HDMI input compliance.

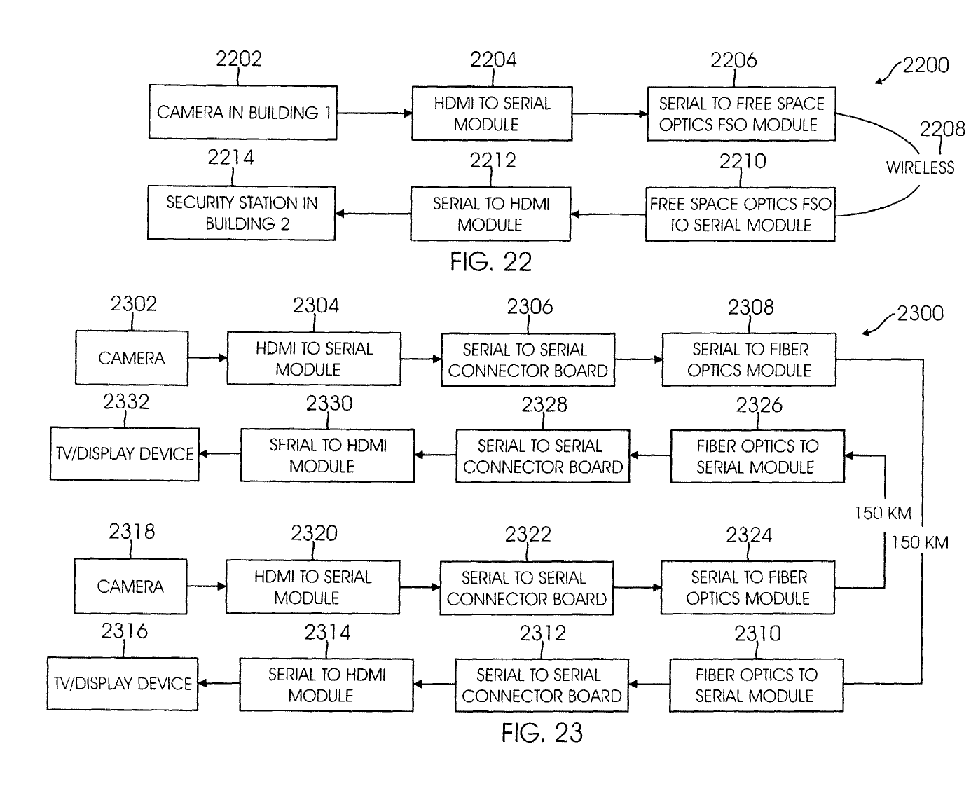

FIG. 22 is a block diagram of a system including multiple HDMI protocol converter modules that can distribute video for a security system in accordance with an embodiment of the present invention. The system 2200 includes a camera 2202 coupled to an HDMI to serial module 2204 coupled to a serial to free space optics module 2206 coupled via a wireless connection 2208 to a free space optics to serial module 2210 coupled to a serial to HDMI module 2212 coupled to a security station 2214. In the illustrated embodiment, the camera 2202, the HDMI to serial converter module 2204, the serial to free space optics module 2206 are located at a first location while the fiber optics to serial module 2210, the serial to HDMI converter module 2214 and the security station 2214 are located at a second location.

In operation, audiovisual content provided by the camera 2202 in the first building can be provided wirelessly to the security station 2214 in the second building. In other embodiments, the audiovisual content can be provided to multiple audiovisual sinks in the second building(s).

FIG. 23 is a block diagram of a video conferencing system including multiple HDMI protocol converter modules that can distribute video over long distances in accordance with an embodiment of the present invention. The system 2300 includes a camera 2302 coupled to an HDMI to serial converter module 2304 coupled to a serial to serial connector board 2306 coupled to a serial to fiber optics module 2308 coupled, over a distance of up to 150 kilometers, to a fiber optics to serial module 2310 coupled to a serial to serial board connector 2312 coupled to a serial to HDMI converter module 2314 coupled to a display device 2316. In the illustrated embodiment, the camera 2302, the HDMI to serial converter module 2304, the serial to serial connector board 2306 and the serial to fiber optics module 2308 are located at a first location while the fiber optics to serial module 2310, the serial to serial board connector 2312, the serial to HDMI converter module 2314 and the display device 2316 are located at a second location.

The system 2300 further includes a camera 2318 coupled to an HDMI to serial converter module 2320 coupled to a serial to serial connector board 2322 coupled to a serial to fiber optics module 2324 coupled, over a distance of up to 150 kilometers, to a fiber optics to serial module 2326 coupled to a serial to serial board connector 2328 coupled to a serial to HDMI converter module 2330 coupled to a display device 2332. In the illustrated embodiment, the camera 2318, the HDMI to serial converter module 2320, the serial to serial connector board 2322 and the serial to fiber optics module 2324 are located at the second location while the fiber optics to serial module 2326, the serial to serial board connector 2328, the serial to HDMI converter module 2330 and the display device 2332 are located at the first location.

In operation, the system can receive audiovisual content from camera 2302 at the first location and transport the content to display device 2316 at the second location. Similarly, the system can receive audiovisual content from camera 2318 at the second location and transport the content to display device 2332 at the first location. In this way, fully functional video conferencing services can be provided by the system.

In one embodiment, the display devices can be televisions, monitors or other devices suitable to display visual content. In one embodiment, other audiovisual data sources can be used instead of the cameras.

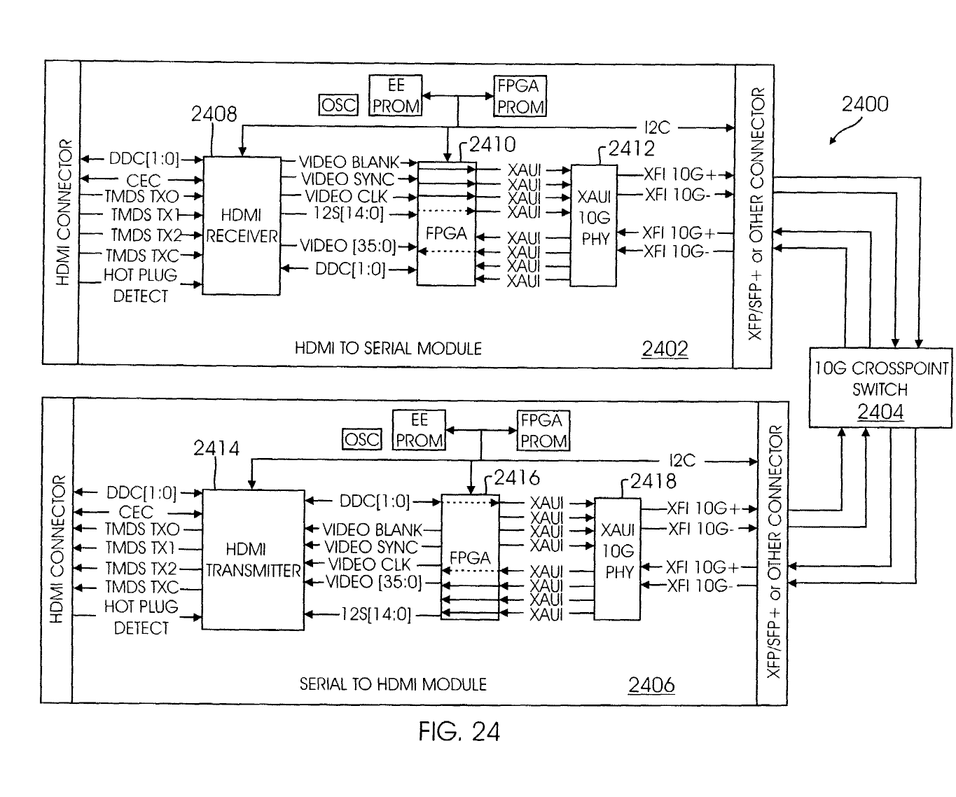

FIG. 24 is a schematic block diagram of a system including two HDMI protocol converter modules and a crosspoint switch in accordance with an embodiment of the present invention. The system 2400 includes a HDMI to serial converter module 2402 coupled to a crosspoint switch 2404 coupled to a serial to HDMI converter module 2406.

The HDMI to serial module 2402 includes an HDMI receiver 2408 coupled to an FPGA 2410 coupled to a XAUI PHY 2412. In the illustrated embodiment, the HDMI receiver 2408 is configured to receive HDMI data and provide the data via a number of parallel data channels to the FPGA 2410. The FPGA 2410 can receive the parallel data channels along with various HDMI control channels and can multiplex the received parallel data onto four XAUI data channels. The XAUI PHY 2412 can receive data from the four XAUI data channels and can serialize the data onto a XFI differential output data channel.

The crosspoint switch 2404 can receive the data from the XAUI PHY 2412. The crosspoint switch can also communicate data back to the XAUI PHY 2412 via another XFI data channel. In a number of embodiments, the data communicated from the crosspoint 2404 to the XAUI PHY 2412 is HDMI control data. The crosspoint switch 2404 can provide data received from the XAUI PHY 2412 to the serial to HDMI module 2406.

The serial to HDMI module 2406 includes an HDMI transmitter 2414 coupled to an FPGA 2416 coupled to a XAUI PHY 2418. The XAUI PHY 2418 can receive data from the HDMI to serial module 2402 via the crosspoint switch 2404 using a XFI serial data channel. The XAUI PHY 2418 can de-multiplex the received XFI data onto four XAUI data channels and provide the data to the FPGA 2416. The FPGA 2416 can de-multiplex the data received from the four XAUI data channels and provide the data on a number of parallel data channels to the HDMI transmitter 2414. The HDMI transmitter 2414 can receive the data via the parallel data channels and provide the data onto the HDMI data channels.

In the illustrated embodiment, the HDMI receiver and HDMI transmitter are ASICs. In one embodiment, the HDMI receiver and HDMI transmitter are provided by Silicon Image, Incorporated of Sunnyvale, Calif. In another embodiment, the HDMI receiver and HDMI transmitter are provided by NXP of Eindhoven, The Netherlands. In a number of embodiments, the use of an ASIC HDMI transmitter and an ASIC HDMI receiver reduce the complexity of embodiments described earlier that implemented the HDMI interfaces using an FPGA or other programmable logic device. In addition, the HDMI ASICs can make use of HDCP keys stored within those ASICs.

In several embodiments, the FPGAs can be implemented using at least one processor and any number of memory components. In one embodiment, the FPGAs are implemented using a combination of programmable logic components (e.g. FPGAs, CPLDs or the like). In another embodiment, the FPGAs can be implemented using any number of discrete logic components. In yet another embodiment, the FPGAs can be implemented using an ASIC.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A system for converting data comprising:
a first interface configured to communicate using an HDMI standard, the first interface receiving HDMI data from a plurality of first communication channels;
a second interface configured to communicate using a second communication protocol, the second interface having at least one second communication channel; and
a circuitry coupled to the first interface and to the second interface, the circuitry configured to:
receive HDMI data from the first interface;
multiplex at least a portion of the HDMI data received via the first interface onto the at least one second communication channel in accordance with the second communication protocol.

2. The system of claim 1, wherein the second communication interface and second communication protocol are defined by any of SFP, SFP+, and XFP.

3. The system of claim 1, wherein the second communication interface is a serial interface.

4. The system of claim 3, wherein the serial interface is configured to use differential signals.

5. The system of claim 3, wherein the serial interface is configured to use optical signals.

6. The system of claim 1, wherein the system is reconfigurable such that the circuitry is configured to:
receive HDMI data from the second interface;
de-multiplex at least a portion of the received HDMI data via the second interface onto the plurality of first communication channels in accordance with the HDMI standard.

7. The system of claim 1, wherein the system is capable of communicating bi-directionally using the first interface.

8. The system of claim 1, further comprising at least one LED:
wherein the first interface comprises a plurality of signals defined by the HDMI standard; and
wherein the at least one LED is coupled to a signal indicative of one of the plurality of signals, the at least one LED configured to indicate a status of the signal.

9. The system of claim 1, further comprising at least one LED:
wherein the first interface comprises a plurality of signals defined by the HDMI standard; and
wherein the at least one LED is coupled to a signal indicative of a combination of any of the plurality of signals, the at least one LED configured to indicate a status of the signal.

10. The system of claim 1, wherein the HDMI data comprises both HDMI control information and HDMI audiovisual information.

11. The system of claim 1, wherein system is implemented using any of an FPGA, a CPLD, and an ASIC.

12. The system of claim 1, wherein the circuitry is implemented using any of an FPGA, a CPLD, and an ASIC.

13. The system of claim 1:
wherein the first interface is implemented using a first ASIC for receiving the HDMI data;
wherein the circuitry includes a second ASIC for outputting serial data in accordance with an XFP protocol; and
wherein the circuitry includes an FPGA configured to receive data from the first ASIC and to provide the data received by the FPGA to the second ASIC using a XAUI protocol.

14. The system of claim 1, wherein the system is implemented using a pluggable module form factor.

15. A system for converting data comprising:
a first interface configured to communicate using a first communication protocol, the first interface for receiving serial data from a first communication channel;
a second interface configured to communicate using an HDMI standard, the second interface having a plurality of second communication channels; and
a circuitry coupled to the first interface and to the second interface, the circuitry configured to:
receive the serial data from the first interface; and
de-multiplex at least a portion of the serial data onto the plurality of second communication channels in accordance with the HDMI standard.

16. The system of claim 15, wherein the first communication interface and first communication protocol are defined by any of SFP, SFP+, and XFP.

17. The system of claim 15, wherein the first interface is configured to use differential signals.

18. The system of claim 15, wherein the first interface is configured to use optical signals.

19. The system of claim 15, wherein the system is reconfigurable such that the circuitry is configured to:
receive HDMI data from the second interface;
multiplex at least a portion of the received HDMI data onto the first communication channel in accordance with the first communication protocol.

20. The system of claim 15, wherein the system is capable of communicating bi-directionally using the second interface.

21. The system of claim 15, further comprising at least one LED:
wherein the second interface comprises a plurality of signals defined by the HDMI standard; and
wherein the at least one LED is coupled to a signal indicative of one of the plurality of signals, the at least one LED configured to indicate a status of the signal.

22. The system of claim 15, further comprising at least one LED:
wherein the second interface comprises a plurality of signals defined by the HDMI standard; and
wherein the at least one LED is coupled to a signal indicative of a combination of any of the plurality of signals, the at least one LED configured to indicate a status of the signal.

23. The system of claim 15, wherein the serial data comprises both HDMI control information and HDMI audiovisual information.

24. The system of claim 15, wherein the system is implemented using any of an FPGA, a CPLD, and an ASIC.

25. The system of claim 15, wherein the circuitry is implemented using any of an FPGA, a CPLD, and an ASIC.

26. The system of claim 15:
wherein the first interface is implemented using a first ASIC for receiving the serial data in accordance with any one of an SFP protocol, an SFP+ protocol, and an XFP protocol;
wherein the circuitry includes a second ASIC for outputting HDMI data in accordance with an the HDMI standard; and
wherein the circuitry includes an FPGA configured to receive data from the first ASIC and to provide the data received by the FPGA to the second ASIC using a XAUI protocol.

27. The system of claim 15, wherein the system is implemented using a pluggable module form factor.

28. A method for communicating HDMI information comprising:
receiving HDMI audiovisual data and HDMI control data from a first interface;
storing the HDMI audiovisual data and HDMI control data;
multiplexing the HDMI audiovisual data and HDMI control data into a transmit data stream provided to a second interface;
de-multiplexing HDMI audiovisual data and HDMI control data from a receive data stream via a second interface;
storing the de-multiplexed HDMI audiovisual data and HDMI control data from the receive data stream;
providing the de-multiplexed HDMI audiovisual data and HDMI control data to the first interface.
